(19) United States
(12) Patent Application Publication
(10) Pub. No.: US 2025/0061871 A1
(43) Pub. Date: Feb. 20, 2025

(54) ELECTRONIC INSTRUMENT, ELECTRONIC CYMBAL SET, AND ELECTRONIC HI-HAT CYMBALS

(71) Applicant: Avedis Zildjian Co., Norwell, MA (US)

(72) Inventors: Tsutomu Tanaka, Matsumoto-Shi (JP); Yoshiomi Yamazaki, Matsumoto-Shi (JP); Tsukasa Arakawa, Matsumoto-Shi (JP); Michael Joseph Snyder, Portland, OR (US)

(21) Appl. No.: 18/720,893

(22) PCT Filed: Dec. 16, 2022
(86) PCT No.: PCT/JP2022/046313

§ 371 Date: Jun. 17, 2024

(30) Foreign Application Priority Data
Dec. 20, 2021 (JP) 2021-205963

(51) Int. Cl. G10H 3/14

(52) U.S. Cl. CPC G10H 3/146; G10H 2220/525; G10H 2230/331

(57) ABSTRACT

An electronic instrument 4 includes a first cymbal 11comprising metal. The first cymbal 11 is electrically conductive. Furthermore, the electronic instrument 4 includes a capacitance-type touch sensor 43, and the first cymbal 11 is used as a touch electrode of the touch sensor 43. Thus, when a performer with capacitance touches the first cymbal 11, the line-to-ground capacitance of the first cymbal 11 changes, and a signal corresponding to the change in line-to-ground capacitance is output from the touch sensor 43. Therefore, when the performer touches the first cymbal 11 in the same manner as when muting a conventional cymbal, a signal indicating mute can be output from the touch sensor 43.

### TECHNICAL FIELD

The present invention relates to an electronic cymbal that is connected to a sound source device and generates a striking sound. It also relates to an electronic cymbal set and electronic hi-hat cymbals equipped with such electronic cymbals. Background

Patent Literative 1 relates to an electronic cymbal pad that can be used as an electronic cymbal. The electronic cymbal pad of Patent Literature 1 has a vibration sensor attached thereto. The vibration sensor detects vibrations that are generated by the electronic cymbal pad when the electronic cymbal pad is struck by a performer. Signals from the vibration sensor are used to acquire the striking point position on the electronic cymbal pad, the striking time point, the intensity of striking, and the like.

The electronic cymbal pad of Patent Literature I also has a membrane switch attached thereto. The membrane switch is a sheet-like touch sensor in a bow shape. When a performer touches the membrane switch, the membrane switch outputs a signal indicating a mute operation. The membrane switch is attached to a part of the outer peripheral edge in a circumferential direction of the electronic cymbal pad.

### CITATION LIST

### Patent Literature

Patent Literature 1: Japanese Patent Application Laid-open No. 2019-191406

### SUMMARY OF INVENTION

### Technical Problem

In the technique of Patent Literature 1, the performer needs to touch the area on the electronic cymbal where the membrane switch is fixed when muting the electronic cymbal. Therefore, when muting the cymbal, it may be necessary to check the area on the electronic cymbal where the membrane switch is fixed. Therefore, when muting the cymbal, the sense of playing felt by the performer may be impaired.

In view of the aforementioned circumstances, it is an object of the present invention to provide an electronic cymbal capable of outputting a signal indicating mute by an operation similar to a case of muting a conventional cymbal. Also, it is to provide an electronic cymbal set and electronic hi-hat cymbals equipped with such electronic cymbals and a control device.

### DISCLOSURE OF INVENTION

### Solution to Problem

In order to overcome such issues described above, an electronic instrument according to the present invention includes: a first cymbal comprising metal; and a capacitance-type touch sensor including a touch electrode, in which the first cymbal is electrically conductive, and the touch electrode is the first cymbal.

The electronic instrument of the present invention includes the first cymbal comprising metal. Thus, when the performer strikes the first cymbal, the performer can have the same sense of playing as when striking a conventional cymbal. Furthermore, the electronic instrument includes the capacitance-type touch sensor, and the first cymbal is used as the touch electrode of the touch sensor. Thus, when the performer with capacitance touches the first cymbal, the line-to-ground capacitance of the first cymbal changes, and a signal corresponding to the change in line-to-ground capacitance is output from the touch sensor. Therefore, when the performer touches the first cymbal in the same manner as when muting the actual cymbal, a signal indicating mute can be output from the touch sensor. This eliminates the need for the performer to check the area the performer is required to touch, when muting the cymbal. Therefore, when muting the cymbal, it is possible to prevent or suppress the loss of the sense of playing for the performer who is playing the electronic instrument.

In the present invention, it is desirable to include: a first vibration sensor configured to detect a vibration of the first cymbal; and a second vibration sensor configured to detect a vibration of the first cymbal on an outer periphery side of the first vibration sensor, in which the first vibration sensor overlaps with a bell of the first cymbal when viewed from a top-and-bottom direction, and the second vibration sensor is disposed at a position that overlaps with an area in the bow of the first cymbal closer to the bell than to an edge. Thereby, the electronic instrument includes the two vibration sensors at different positions in the radial direction of the first cymbal. Therefore, it is easy to acquire the striking point position on the first cymbal based on the signals output from each of the two vibration sensors.

The present invention may include: a substrate where a circuit part of the touch sensor is formed; a resin holder that supports the substrate and the first vibration sensor; and a plurality of headed screws for fixing the holder to a bottom face of the first cymbal, in which the first cymbal includes a center hole, the holder includes a cylindrical part inserted into the center hole, and a plurality of bosses arranged in an annular form on an outer periphery side of the cylindrical part, an outer peripheral face of the cylindrical part comes in contact with an inner wall face of the center hole of the first cymbal, a screw hole that can be engaged with the headed screw is provided in a top face of each of the bosses, and the holder is fixed to the first cymbal by having each of the headed screws inserted into the first cymbal from an upper side toward a lower side and screwed into the screw hole of each of the bosses. Thereby, the holder supporting the substrate and the first vibration sensor can be attached to the first cymbal.

The present invention may include: a substrate where a circuit part of the touch sensor is formed; a resin holder that supports the substrate and the first vibration sensor; and a plurality of headed screws for fixing the holder to a bottom face of the first cymbal, in which the first cymbal includes a center hole, the holder includes a cylindrical part inserted into the center hole, and a plurality of bosses arranged in an annular form on an outer periphery side of the cylindrical part, an outer peripheral face of the cylindrical part comes in contact with an inner wall face of the center hole of the first cymbal, a screw hole that can be engaged with the headed screw is provided in a top face of each of the bosses, and the holder is fixed to the first cymbal by having each of the headed screws inserted into the first cymbal from an upper side toward a lower side and screwed into the screw hole of each of the bosses. Thereby, it is easy to use the first cymbal as the touch electrode by electrically connecting the circuit part of the touch sensor and the first cymbal. Furthermore, since the headed screws used to fix the holder to the first cymbal are conductive, the circuit part of the touch sensor and the first cymbal are electrically connected via the terminal and the headed screws. This makes it possible to secure the connection between the circuit part of the touch sensor and the first cymbal.

In the present invention, the bosses may encircle the bell on the outer periphery side of the bell, when the holder is fixed to the first cymbal. In this way, the holder is fixed to the first cymbal while being in contact with the opening edge of the center hole of the first cymbal and the outer periphery side of the bell. Thus, when the first cymbal is struck, the holder functions as a damper for attenuating the vibration of the bell at an early stage. Since the first cymbal is made of, or comprises, metal, the vibration caused by striking is prone to generate undulation, and the amplitude repeatedly increases and decreases. Therefore, there is an issue that the striking time point, which is the time point of maximum amplitude, is easily mis-detected from the amplitude of the first cymbal. For such an issue, when the holder functions as the damper for attenuating the vibration of the bell at an early stage, it becomes easy to acquire the striking time point based on the signal from the first vibration sensor.

In the present invention, the holder may include, as the bosses, a plurality of first bosses arranged in an annular form, and a plurality of second bosses arranged in an annular form between the first bosses and the cylindrical part, and the holder is fixed to the first cymbal by having each of the headed screws screwed into the screw hole of each of the first bosses or screwed into the screw hole of each of the second bosses. In this way, when fixing the holder to the first cymbal, the bosses into which the headed screws are screwed can be selected between the first bosses and the second bosses positioned on the inner periphery side thereof. Therefore, when there are two types of first cymbals with different sizes in the radial direction as the first cymbal, for example, it is possible to share a single holder by those two types of first cymbals. In this case, when the holder is fixed to the first cymbal by screwing each of the headed screws into the screw holes of each of the first bosses, the first bosses may be positioned on the outer periphery side of the bell and the second bosses can overlap with the bell when viewed from the top-and-bottom direction. Furthermore, when the holder is fixed to the first cymbal by screwing each of the headed screws into the screw holes of each of the second bosses, the first bosses and the second bosses may be positioned on the outer periphery side of the bell. In this way, the bosses can be positioned on the outer periphery side of the bell when a single holder is shared by two types of first cymbals with different sizes in the radial direction.

In the present invention, the bosses may encircle the center hole in the bell at a position closer to the center hole than to the bow, when the holder is fixed to the first cymbal, and on a further outer periphery side than the bosses, the holder has no part that comes in contact with the first cymbal. Thereby, the holder is fixed to the first cymbal at a position close to the center of the first cymbal. Thus, the sound generated when the first cymbal is struck becomes closer to that of the actual cymbal when struck, compared to the case where the holder contacts the first cymbal on the outer periphery side of the bell. Therefore, the sense of playing when the performer strikes the first cymbal can be made closer to the sense of playing when striking a conventional cymbal. On the other hand, the holder comes in contact with the first cymbal at a position close to the center of the first cymbal in the opening edge of the center hole of the first cymbal and the bell. Thus, the holder fixed to the first cymbal functions as the damper for attenuating the vibration of the bell at an early stage. Since the first cymbal is made of, or comprises, metal, the vibration caused by striking is prone to generate undulation, and the amplitude repeatedly increases and decreases. Therefore, there is an issue that the striking time point, which is the time point of maximum amplitude, tends to be mis-detected. For such an issue, when the holder functions as the damper for attenuating the vibration of the bell at an early stage, it becomes easy to acquire the striking time point based on the signal from the first vibration sensor.

The present invention may include: a substrate where a circuit part of the touch sensor is formed; a resin holder that supports the substrate and the first vibration sensor; a nut for fixing the holder to the first cymbal; a lead wire that electrically connects the circuit part of the touch sensor and the first cymbal; and a conductive member connected to the lead wire, in which the first cymbal includes a center hole, the holder includes a cylindrical part that is inserted into the center hole, an annular plate part spread toward an outer periphery side from a bottom end of the cylindrical part, and a male thread provided on an outer peripheral face of the cylindrical part, the annular plate part includes a mount part for placing the conductive member, the nut is screwed onto the male thread of the cylindrical part protruding to an upper side from the first cymbal, and abuts against an opening edge of the center hole of the first cymbal, the conductive member is sandwiched between the mount part and the opening edge, and, on a further outer periphery side than the annular plate part, the holder has no part that comes in contact with the first cymbal. Thereby, the holder is fixed to the first cymbal at a position close to the center of the first cymbal. Therefore, the sound generated when the first cymbal is struck becomes closer to that of the actual cymbal when struck, compared to the case where the bosses for fixing the holder to the first cymbal encircles the bell on the outer periphery side of the bell. This makes it easier for the performer to get the same sense of playing as when striking the actual cymbals. On the other hand, the holder is fixed to the bell by the nut that has a relatively large contact area with the first cymbal. Thus, the holder fixed to the first cymbal functions as the damper for attenuating the vibration of the bell at an early stage. Since the first cymbal is made of, or comprises, metal, the vibration caused by striking is prone to generate undulation, and the amplitude repeatedly increases and decreases. Therefore, there is an issue that the striking time point, which is the time point of maximum amplitude, tends to be mis-detected. For such an issue, when the holder functions as the damper for attenuating the vibration of the bell at an early stage, it becomes easy to acquire the striking time point based on the signal from the first vibration sensor. By screwing the nut onto the cylindrical part, the conductive member is sandwiched between the first cymbal and the mount part. Thereby, the circuit part of the touch sensor is connected to the first cymbal via the lead wire and the conductive member. This makes it easy to use the first cymbal as the touch electrode of the touch sensor.

The present invention may include: a second holder that supports the second vibration sensor; and two second headed screws for fixing the second holder to a bottom face of the first cymbal, in which the second holder includes: a sensor support part that supports the second vibration sensor; a first screw hole provided on one side of the sensor support part; and a second screw hole provided on an opposite side from the first screw hole of the sensor support part, the second holder is fixed to the first cymbal by having each of the second headed screws inserted into the first cymbal from an upper side to a lower side and screwed into the first screw hole and the second screw hole, and the two second headed screws are arranged in a radial direction of the first cymbal, when the second holder is fixed to the first cymbal. Thereby, it becomes easier to detect the vibration of the first cymbal by the second vibration sensor. In other words, when the first cymbal is struck, the vibration is propagated in the circumferential direction as a bow undulation. Therefore, in a case where the two headed screws for fixing the second holder are arranged in the circumferential direction of the first cymbal when the second holder is fixed to the first cymbal, the undulation of the bow tends to be inhibited by the two headed screws and the second holder, and the amplitude of the vibration caused by striking tends to become small. On the contrary, when the two headed screws for fixing the second holder are arranged in the radial direction of the first cymbal, the undulation of the bow propagating in the circumferential direction can be prevented from being hindered by the two headed screws and the second holder. Thus, it is possible to suppress reduction in the amplitude of the vibration caused by striking. Therefore, it becomes easier to acquire the amplitude of the vibration corresponding to the intensity of the striking by the second vibration sensor.

Note here that the electronic hi-hat cymbals can be configured by having the first cymbal and the second cymbal supported on a commercially available hi-hat stand and disposing the second cymbal coaxially on a lower side of the first cymbal. When the first cymbal and the second cymbal are used as the electronic hi-hat cymbals, the isolated distance between the first cymbal and the second cymbal in the top-and-bottom direction changes by stepping on the pedal of the hi-hat stand. Therefore, in order to reproduce the striking sound that changes in accordance with the change in the isolated distance, it is necessary to have a distance sensor that outputs a signal to acquire the isolated distance between the first cymbal and the second cymbal.

For that, the present invention may include: a substrate where a circuit part of the touch sensor is formed; a resin holder that supports the substrate and the first vibration sensor, the holder being fixed to an underside of the first cymbal; a second cymbal comprising metal disposed coaxially on a lower side of the first cymbal; and a distance sensor that is supported on the holder, and outputs a signal corresponding to an isolated distance between the first cymbal and the second cymbal in the top-and-bottom direction, in which the second cymbal is electrically conductive, the distance sensor includes an oscillation circuit having a coil with an opening facing the top-and-bottom direction, the distance sensor outputting a signal oscillated by the oscillation circuit, and the coil is fixed to the holder and positioned on the lower side than the first cymbal. Note here that the second cymbal comprises metal that is electrically conductive. Therefore, the frequency and amplitude of the signal oscillated by the oscillation circuit vary in accordance with the isolated distance between the first cymbal and the second cymbal. Therefore, it is possible to output a signal corresponding to the isolated distance between the first cymbal and the second cymbal from the distance sensor. Furthermore, since the coil is positioned on the lower side than the first cymbal, the isolated distance between the first cymbal and the second cymbals can be detected with high accuracy.

Furthermore, the present invention may include: a substrate where a circuit part of the touch sensor is formed; a resin holder that supports the substrate and the first vibration sensor, the holder being fixed to an underside of the first cymbal; a second cymbal disposed coaxially on a lower side of the first cymbal; and a distance sensor that is supported on the holder, and outputs a signal corresponding to an isolated distance between the first cymbal and the second cymbal in the top-and-bottom direction, in which the second cymbal includes a conductive metal member, the distance sensor includes an oscillation circuit having a coil with an opening facing the top-and-bottom direction, the distance sensor outputting a signal oscillated by the oscillation circuit, and the coil is fixed to the holder and positioned on the lower side than the first cymbal. In this manner, it is also possible to output a signal corresponding to the isolated distance between the first cymbal and the second cymbal from the distance sensor regardless of the material of the second cymbal. Furthermore, since the coil is positioned on the lower side than the first cymbal, the isolated distance between the first cymbal and the second cymbals can be detected with high accuracy.

The present invention may include: a cable, and a cable guide, in which the second cymbal includes a wiring hole that is provided in a part of a circumferential direction and opened through the top-and-bottom direction, the substrate includes a connector that is electrically connected to the touch sensor, the first vibration sensor, the second vibration sensor, and the distance sensor, the cable is connected to the connector in a detachable manner while being inserted through the wiring hole from a lower side of the second cymbal, and the cable guide is fixed to the second cymbal while being inserted through the wiring hole, and includes a pair of opposing parts opposing to the cable from both sides of the circumferential direction at positions away from the second cymbal toward the lower side.

In this way, signals from the touch sensor, the first vibration sensor, the second vibration sensor, and the distance sensor can be taken out to the outside via the cable. Furthermore, the cable is connected at its upper end to the connector of the substrate supported by the holder, which extends downward from the connector and goes through the wiring hole provided in the second cymbal. Furthermore, the cable is in a state where displacement in the circumferential direction is regulated by a pair of opposing parts of the cable guide fixed to the second cymbal. Thus, for example, when the first cymbal supported by the hi-hat stand is to rotate in the circumferential direction by being struck, the pair of opposing parts of the cable guide interfere with the cable from the circumferential direction to restrict the relative rotation of the first cymbal and the second cymbal. In addition, the cable inserted through the second cymbal and extends toward the lower side is routed around while being in contact with the floor face or the like, so that the movement of the cable itself is restricted by the floor face. As a result, the first cymbal and the second cymbal are prevented from rotating excessively. By preventing or suppressing excessive rotation of the first cymbal, it is possible to prevent or suppress excessive displacement of the positions of the first vibration sensor and the second vibration sensor attached to the first cymbal in the circumferential direction. This makes it possible to suppress an excessive change in the level of the signals from the first vibration sensor and the second vibration sensor due to an excessive change in the distance between the striking position of the performer and the first vibration sensor and the second vibration sensor due to the rotation of the first cymbal.

In the present invention, the second cymbal may have a smaller outer diameter than an outer diameter of the first cymbal, and an outer peripheral edge of a top face of the second cymbal may be covered with a shock absorbing member. Thereby, when the first cymbal made of, or comprising, metal and the second cymbal made of, or comprising, metal come in contact with each other, it is possible to prevent or suppress the first cymbal from being scratched. Furthermore, since the outer peripheral edge of the top face of the second cymbal is covered with the shock absorbing member, the fluttering sound generated when the first cymbal and the second cymbal are played with an opening that allows a slight contact between the first cymbal and the second cymbal is not transmitted to the first vibration sensor and the second vibration sensor.

Next, a cymbal set according to the present invention includes: the electronic instrument described above; and a control device connected to the electronic instrument via the cable, in which the control device includes: an attack signal generation unit configured to generate an attack signal indicating a striking time point based on an output from the first vibration sensor; a dynamic signal generation unit configured to generate a dynamic signal indicating an intensity of striking based on an output from the second vibration sensor; a striking position signal generation unit configured to generate a striking position signal indicating a striking position on the first cymbal based on an output from the first vibration sensor and an output from the second vibration sensor; a mute signal generation unit configured to generate a mute signal indicating mute based on an output from the touch sensor; an isolated distance signal generation unit configured to generate an isolated distance signal indicating the isolated distance based on an output from the distance sensor; and an output unit configured to output the attack signal, the dynamic signal, the striking position signal, the mute signal, and the isolated distance signal to outside.

According to the present invention, the control device connected to the electronic instrument via the cable generates an attack signal indicating the striking time point based on the output from the first vibration sensor. Since the first cymbal comprises metal, the vibration caused by striking is prone to generate undulation, and the amplitude repeatedly increases and decreases. Therefore, there may be an issue that the attack signal with the time point of maximum amplitude acquired to be the striking time point tends to be mis-detected. For such an issue, the signal from the first vibration sensor disposed in a position overlapping with the bell of the first cymbal has fewer low-frequency band components than the signal from the second vibration sensor disposed in a position overlapping with the bow, and its amplitude tends to be attenuated over time. Furthermore, the amplitude of the vibration of the bell is easily attenuated by the holder fixed to the first cymbal. Therefore, by acquiring the attack signal based on the signal from the first vibration sensor, it is possible to prevent or suppress the attack signal generation unit from mis-detecting the attack signal. Furthermore, the signal from the second vibration sensor disposed in the position overlapping with the bow has more low-frequency band components than the signal from the first vibration sensor disposed at the position overlapping with the bell, so that it is easier to acquire the amplitude of the vibration corresponding to the intensity of striking. Therefore, the dynamic signal generation unit can easily generate a dynamic signal indicating the intensity of the striking based on the signal from the second vibration sensor. In addition, the control device includes the output unit for outputting the attack signal, the dynamic signal, the striking position, the mute signal, and the isolated distance signal generated based on the output from each of the sensors of the electronic cymbal. Therefore, by inputting the signal from the output unit of the control device to a sound source device, it is possible to generate the striking sound corresponding to the striking of the electronic cymbal from the sound source device.

Next, electronic hi-hat cymbals according to the present invention include: the electronic cymbal set described above; and a hi-hat stand, in which the hi-hat stand includes: a first support part that supports the first cymbal; a second support part that supports the second cymbal; and a lifting mechanism that lifts up and down the first support part, in which when the first cymbal supported by the first support part is lifted up and down, the coil moves together with the first cymbal on the lower side than the first cymbal.

### BRIEF DESCRIPTION OF DRAWINGS

FIG. 1 is an explanatory diagram of electronic hi-hat cymbals.

FIG. 2 is a perspective view when an electronic cymbal is viewed from above.

FIG. 3 is a perspective view when the electronic cymbal is viewed from below.

FIG. 4 is a sectional view of the electronic cymbal.

FIG. 5 is an exploded perspective view of a first cymbal unit.

FIG. 6 is a fragmentary enlarged sectional view of an area around a first vibration sensor.

FIG. 7 is an exploded perspective view of a second cymbal unit.

FIG. 8 is a schematic block diagram of a control system of the electronic hi-hat cymbals.

FIG. 9 is a perspective view of another example of the second cymbal unit.

FIG. 10 is an explanatory diagram of electronic hi-hat cymbals according to a second embodiment.

FIG. 11 is a sectional view of an electronic cymbal of FIG. 10.

FIG. 12 is an exploded perspective view of a first cymbal unit of FIG. 10.

FIG. 13 is an explanatory diagram of electronic hi-hat cymbals according to a third embodiment.

FIG. 14 is a sectional view of an electronic cymbal of FIG. 13.

FIG. 15 is an exploded perspective view of a first cymbal unit of FIG. 13.

### DESCRIPTION OF EMBODIMENTS

Hereinafter, an electronic cymbal, an electronic cymbal set, and electronic hi-hat cymbals according to embodiments of the present invention will be described with reference to the accompanying drawings.

### First Embodiment

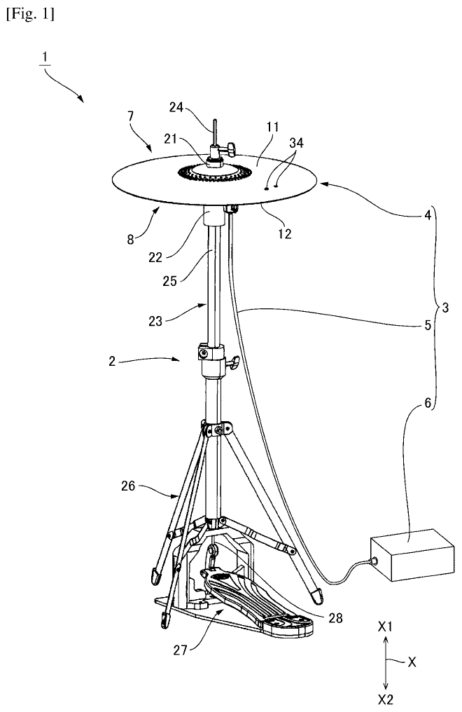

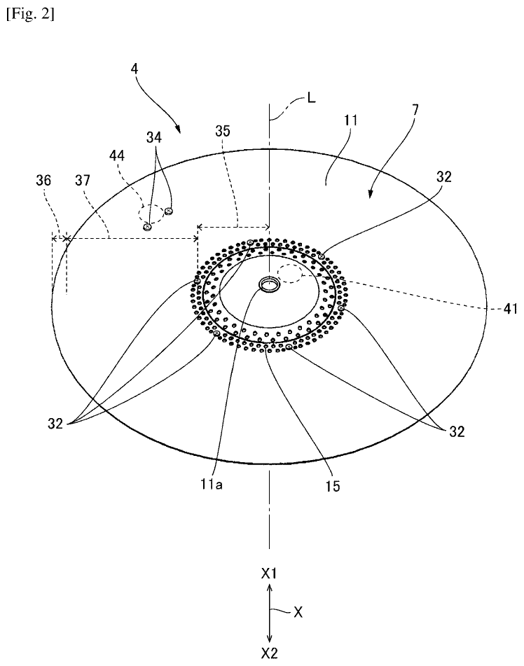

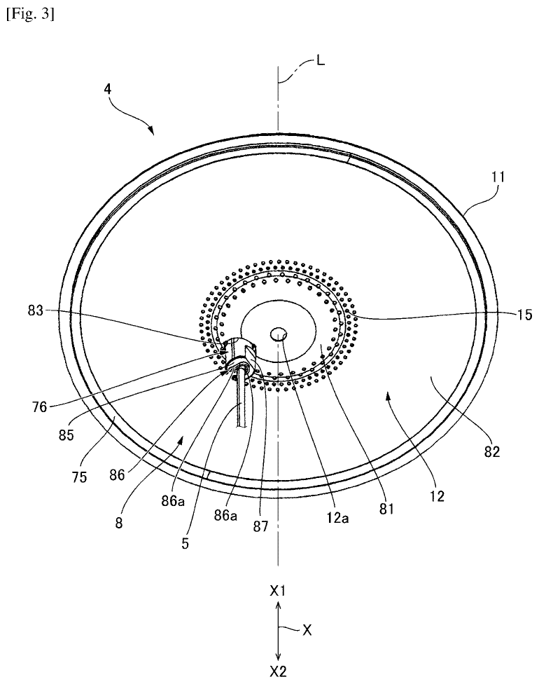

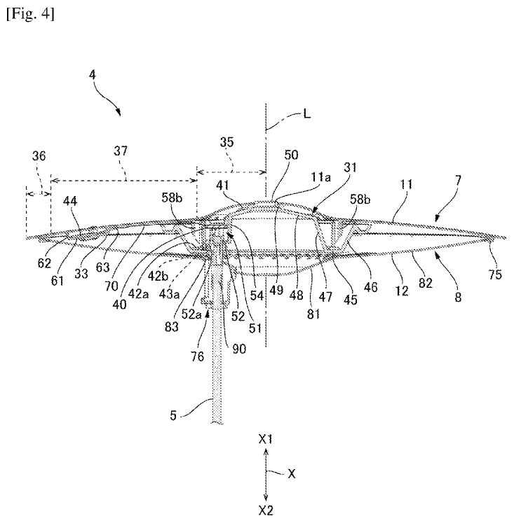

FIG. 1 is an explanatory diagram of the electronic hi-hat cymbals. FIG. 2 is a perspective view when the electronic cymbal is viewed from above. FIG. 3 is a perspective view when the electronic cymbal is viewed from below. FIG. 4 is a sectional view of the electronic cymbal. Electronic hi-hat cymbals 1 of the present embodiment include an electronic instrument 4 supported on a commercially available hi-hat stand 2, and a module 6 (control device) electrically connected to the electronic instrument 4 via a cable 5. The electronic instrument 4, the cable 5, and the module 6 configure an electronic cymbal set 3. In the present embodiment, the electronic instrument 4 includes a first cymbal unit 7 and a second cymbal unit 8.

The first cymbal unit 7 includes a first cymbal 11 made of, or comprising, metal. The second cymbal unit 8 includes a second cymbal 12 made of, or comprising, metal. The first cymbal 11 and the second cymbal 12 both exhibit conductivity (e.g., are electrical conductors, are electrically conductive). As illustrated in FIG. 2 and FIG. 4, the center part of the first cymbal 11 is positioned higher than the outer peripheral edge. As illustrated in FIG. 3 and FIG. 4, the center part of the second cymbal 12 is positioned lower than the outer peripheral edge. As illustrated in FIG. 4, the external dimension of the first cymbal 11 is larger than that of the second cymbal 12. Note that the first cymbal 11 and the second cymbal 12 may be provided with a great number of small holes 15 opened through in the top-and-bottom direction on the entire surfaces thereof to suppress the volume of the striking sound when the first cymbal 11 is struck.

As illustrated in FIG. 1, the first cymbal unit 7 and the second cymbal unit 8 are each supported by the hi-hat stand 2. Thereby, the second cymbal 12 is disposed coaxially on a lower side of the first cymbal 11. In the description below, the direction along a center axis line L of the first cymbal unit 7 and the second cymbal unit 8 is referred to as a top-and-bottom direction X. The side where the first cymbal unit 7 is positioned in the axial direction is referred to as an upper side X1, and the opposite side thereof is referred to as a lower side X2.

Note here that the hi-hat stand 2 includes a first support part 21 that supports the first cymbal 11, a second support part 22 that supports the second cymbal 12, and a lifting mechanism 23 that lifts up and down the first support part 21. The lifting mechanism 23 includes an extension rod 24, a hollow shaft 25, and a leg part 26 that supports the hollow shaft 25 in an upright position. The extension rod 24 is inserted into the hollow shaft 25 in a movable manner in the top-and-bottom direction X, and it is energized to a prescribed upper-side position by a spring, not illustrated. The first support part 21 is provided to the extension rod 24. The first cymbal unit 7 is rotatably supported by the first support part 21, with the extension rod 24 being inserted through its center hole 11a. The second support part 22 is provided to the hollow shaft 25. The second cymbal 12 is rotatably and tiltably supported by the second support part 22, with a hollow shaft 25 being inserted through its center hole 12a. The center axis line L of the first cymbal unit 7 and the second cymbal unit 8 coincides with the axis lines of the extension rod 24 and hollow shaft 25.

The lifting mechanism 23 includes a step-on pedal part 27, and a link mechanism 28 that lifts up and down the extension rod 24 in conjunction with a stepping operation of the pedal part 27. With the pedal part 27 being released, the extension rod 24 is disposed on the upper-side position. Thus, the first cymbal 11 supported by the first support part 21 of the extension rod 24 is isolated from the second cymbal 12 supported by the second support part 22 of the hollow shaft 25 toward the upper side X1. When the pedal part 27 is stepped on, the extension rod 24 moves downward. This causes the first cymbal 11 supported by the first support part 21 to move downward and approach the second cymbal 12. When the pedal part 27 is fully stepped on, the first cymbal 11 comes in contact with the lower pad part.

### First Cymbal Unit

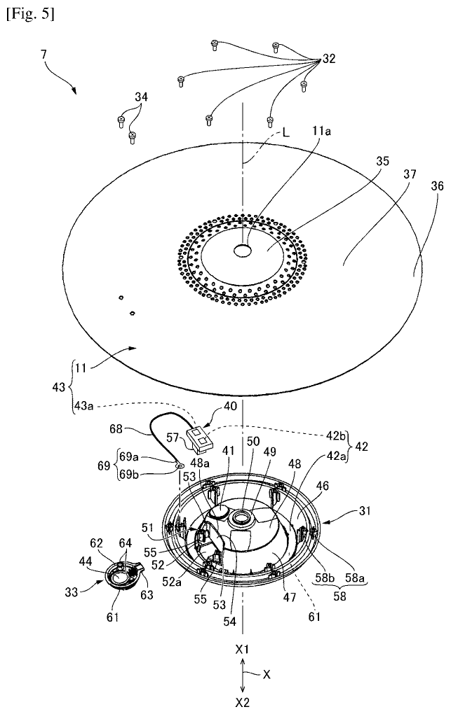

FIG. 5 is an exploded perspective view of the first cymbal unit 7. The first cymbal unit 7 includes the first cymbal 11 and a first holder 31 (holder) attached to the bottom face of the first cymbal 11. The first holder 31 is in an annular shape. The first holder 31 is fixed to the first cymbal 11 by six metallic headed screws 32. Each of the headed screws 32 is electrically conductive. The first cymbal unit 7 also includes a second holder 33 (second holder) attached to a part of the outer periphery side in the circumferential direction of the bottom face of the first cymbal 11. The second holder 33 is fixed to the first cymbal 11 by two headed screws 34 (second headed screws).

As illustrated in FIG. 2 and FIG. 4, the first cymbal 11 has, in the center thereof, a dome-shaped part protruding upward. In the first cymbal 11, the dome-shaped part is referred to as a bell 35. In the first cymbal 11, the outer peripheral edge part is referred to as an edge 36. In the first cymbal 11, the space between the bell 35 and the edge 36 is referred to as a bow 37. The bow 37 slopes to the lower side X2 toward the outer periphery side. The center of the bell 35, that is, the center of the first cymbal 11, is provided with a center hole 11a where the extension rod 24 goes through when supported by the hi-hat stand 2.

As illustrated in FIG. 4, the first holder 31 holds a substrate 40, a first vibration sensor 41 that detects the vibration of the first cymbal 11, and a coil 42a of a distance sensor 42. A circuit part 42b of the distance sensor 42 and a circuit part 43a of a touch sensor 43 that detects that a performer has touched the first cymbal 11 are formed on the substrate 40. The second holder 33 holds a second vibration sensor 44 that detects the vibration of the first cymbal 11 on the outer periphery side of the first vibration sensor 41.

### First Holder

The first holder 31 is attached to the bottom face of the first cymbal 11. The first holder 31 is made of, or comprises, resin. The first holder 31 includes: an annular plate part 45 perpendicular to the center axis line L of the first cymbal 11; an outer tapered plate part 46 sloping upward to the upper side X1 from the edge on the outer periphery side of the annular plate part 45 toward the outer periphery side; an inner tapered plate part 47 sloping upward to the upper side X1 from the edge on the inner periphery side of the annular plate part 45 toward the inner periphery side; and an annular center plate part 48 sloping toward the inner periphery side from the upper edge of the inner tapered plate part 47 toward the upper side X1. The center plate part 48 is provided with: an annular protrusion part 49 protruding toward the upper side X1 at its center part; and a circular cylindrical part 50 extending toward the upper side X1 from an opening edge of the center hole 11a in the protrusion part 49.

As illustrated in FIG. 5, a recessed part 51 recessed onto the inner periphery side is provided in a part of the inner tapered plate part 47 in the circumferential direction. Furthermore, a notch part 48a recessed onto the inner periphery side by corresponding to the recessed part 51 is provided in a part of the center plate part 48 in the circumferential direction. The recessed part 51 includes: a bottom plate part 52 extending in a direction orthogonal to the center axis line L; a pair of side plate parts 53 extending toward the upper side X1 from both edges of the bottom plate part 52 in the circumferential direction; and a connection plate part 54 that extends in the circumferential direction and connects the edges of the pair of side plate parts 53 on the inner periphery side. The center plate part 48 continues from the upper edges of each of the side plate parts 53 to the upper edge of the connection plate part 54.

An opening part 52a is provided in the center part of the bottom plate part 52 in the circumferential direction. A substrate fixation part 55 is provided in each of both sides of the opening part 52a in the circumferential direction in the bottom plate part 52. The substrate 40 is fixed to a pair of the substrate fixation parts 55 from the upper side X1. Note here that a connector 57 is attached to the bottom face of the substrate 40. With the substrate 40 being fixed to the pair of substrate fixation parts 55, the connector 57 can be visually recognized from the lower side X2 of the first holder 31 through the opening part 52a.

The annular plate part 45 has six bosses 58 arranged in an annular form at the outer edge part near the outer tapered plate part 46. In the top face of each of the bosses 58, a screw hole that can be engaged with the headed screw 32 is provided. In the present embodiment, the bosses 58 include six first bosses 58a provided in continuous positions on the inner side of the radial direction of the outer tapered plate part 46; and six second bosses 58b arranged in an annular form between the first bosses 58a and the inner tapered plate part 47.

In the present embodiment, each of the headed screws 32 is inserted through the first cymbal 11 from the upper side X1 to the lower side X2 and screwed into the screw hole in each of the second bosses 58b. Thereby, the first holder 31 is fixed to the first cymbal 11. As illustrated in FIG. 4, with the first holder 31 being fixed to the first cymbal 11, the top face of the protrusion part 49 of the first holder 31 abuts against the opening edge of the center hole 11a in the first cymbal 11 from the lower side X2. Furthermore, the cylindrical part 50 of the first holder 31 fits into the center hole 11a of the first cymbal 11. As a result, the outer peripheral face of the cylindrical part 50 comes in contact with the inner wall face of the center hole 11a in the first cymbal 11. The second bosses 58b, into which the headed screws 32 are screwed, encircle the bell 35 on the outer periphery side of the bell 35. In the present embodiment, the second bosses 58b are provided at positions adjacent to the bell 35 in the bow 37. The six first bosses 58a, into which the headed screws 32 are not screwed, encircle the bell 35 more peripherally than the second bosses 58b.

In the electronic instrument 4 of the present embodiment, as the first cymbal 11, cymbals of a plurality of sizes can be used. For example, when using a large-sized first cymbal 11 having a larger external diameter than that of the first cymbal 11 of the present embodiment and the bell 35 with a larger external diameter than that of the bell 35 of the present embodiment, the bosses 58 into which the headed screws 32 are screwed are defined to be the first bosses 58a. In this case, when the first holder 31 is fixed to the first cymbal 11, the first bosses 58a, into which the headed screws 32 are screwed, encircle the bell 35 on the outer periphery side of the bell 35. The six second bosses 58b, into which the headed screws 32 are not screwed, are disposed at positions overlapping with the bell 35 when viewed from the top-and-bottom direction X.

When the first holder 31 is fixed to the first cymbal 11, the annular plate part 45 is positioned on the lower side X2 than the edge 36 of the first cymbal 11. In other words, the annular plate part 45 is positioned away from the first cymbal 11 toward the lower side X2.

### Second Holder

The second holder 33 includes: a circular sensor support part 61; a frame part 62 extending upward to the upper side X1 from the outer peripheral edge of the sensor support part 61; and a wiring lead-out part 63 extending toward the outer side in the radial direction by notching a part of the frame part 62 in the circumferential direction. The sensor support part 61 has a boss 64 at two opposing positions in the circumferential direction. The top face of each of the bosses 64 is provided with a screw hole that can be engaged with the headed screws 34. The second holder 33 is fixed to the first cymbal 11 by the headed screws 34 that are inserted through the first cymbal 11 and screwed into the screw holes of each of the bosses 64.

### Sensor

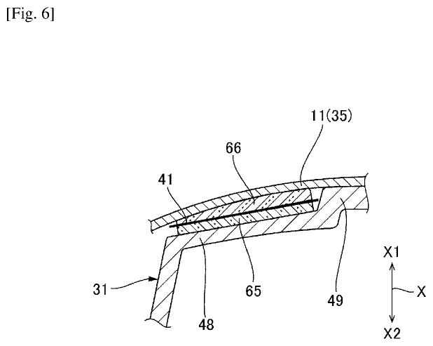

FIG. 6 is an explanatory diagram illustrating an attached state of the first vibration sensor 41. FIG. 6 is a fragmentary enlarged sectional view of the first vibration sensor 41. The first vibration sensor 41 includes a piezoelectric element. The first vibration sensor 41 converts the vibration of the first cymbal 11 into an electrical signal and outputs it. As illustrated in FIG. 4 and FIG. 5, the first vibration sensor 41 is placed on the center plate part 48 of the first holder 31. Thus, the first vibration sensor 41 overlaps with the bell 35 when viewed from the top-and-bottom direction X. As illustrated in FIG. 6, the first vibration sensor 41 is placed on the center plate part 48 via a sheet-like first clastic member 65. The first elastic member 65 is, for example, a sponge. Furthermore, the first vibration sensor 41 comes in contact with the bottom face of the bell 35 via a sheet-like second elastic member 66. Thus, the first vibration sensor 41 detects the vibration of the first cymbal 11 (mainly the vibration of the bell 35) via the second elastic member 66. The second elastic member 66 is a electrically insulating member, and it is harder (e.g., having a higher Shore hardness rating) than the first elastic member 65. In the present embodiment, the second elastic member 66 is, or comprises, rubber. The first vibration sensor 41 is connected to the substrate 40 via a lead wire, not illustrated.

The touch sensor 43 is a capacitance type. As illustrated in FIG. 5, the touch sensor 43 includes the circuit part 43a provided on the substrate 40, and a touch electrode. In the present embodiment, the touch electrode is the first cymbal 11. Therefore, when a performer with capacitance touches the first cymbal 11, the line-to-ground capacitance of the first cymbal 11 changes. As a result, an electrical signal corresponding to the change in the line-to-ground capacitance is output from the touch sensor 43. In other words, when the performer executes a mute operation by touching the first cymbal 11, a signal corresponding to the mute operation is output from the touch sensor 43.

For allowing the first cymbal 11 to be the touch electrode, the first cymbal unit 7 includes a lead wire 68 that electrically connects the substrate 40 to the first cymbal 11, and a conductive terminal 69. The terminal 69 includes a connection part 69a to which the lead wire 68 is connected, and a through-hole 69b where the shaft of the headed screw 32 can be inserted. When the first holder 31 is fixed to the first cymbal 11, the terminal 69 is sandwiched between the top face of the first boss 58a closest to the recessed part 51 among the six first bosses 58a and the first cymbal 11, with the headed screw 32 being inserted through the through-hole 69b. Thereby, the terminal 69 and the first cymbal 11 come in contact and are electrically connected, so that the first cymbal 11 functions as the touch electrode of the touch sensor 43. Furthermore, since the headed screws 32 for fixing the first holder 31 to the first cymbal 11 are conductive, the circuit part 43a of the touch sensor 43 and the first cymbal 11 are electrically connected via the terminal 69 and the headed screws 32. This makes it possible to secure the connection between the circuit part 43a of the touch sensor 43 and the first cymbal 11.

The distance sensor 42 is a proximity sensor that includes an oscillation circuit with the coil 42a, and outputs a signal oscillated by the oscillation circuit. The coil 42a is fixed to the annular plate part 45 of the first holder 31 in an orientation with the opening facing the top-and-bottom direction X. The coil 42a encircles the inner tapered plate part 47. The coil 42a is positioned on the lower side X2 than the edge 36 of the first cymbal 11. In other words, the first holder 31 supports the coil 42a at a position away from the first cymbal 11 toward the lower side X2. The circuit part 42b of the distance sensor 42 is provided on the substrate 40.

Note here that the second cymbal 12 is made of, or comprises, metal exhibiting electrical conductivity. Thus, the frequency and amplitude of the signal oscillated by the oscillation circuit vary by corresponding to the isolated distance between the first cymbal 11 and the second cymbal 12. Therefore, it is possible to output a signal corresponding to the isolated distance between the first cymbal 11 and the second cymbal 12 from the distance sensor 42.

The second vibration sensor 44 includes a piezoelectric element. In the present embodiment, the first vibration sensor 41 and the second vibration sensor 44 are of the same type. The second vibration sensor 44 converts the vibration of the first cymbal 11 into an electrical signal and outputs it. As illustrated in FIG. 4, the second vibration sensor 44 is fixed to the sensor support part 61 of the second holder 33. With the second holder 33 being fixed to the first cymbal 11, the second vibration sensor 44 overlaps with a part of the bow 37 closer to the edge 36 than to the bell 35.

Here, the second vibration sensor 44 opposes to the bow 37 with a gap provided therebetween. From the second vibration sensor 44, a wiring 70 extending toward the inner side of the radial direction is led out via the wiring lead-out part 63 of the second holder 33. The wiring 70 is routed in a straight line form along the bottom face of the first cymbal 11, and connected to the substrate 40. The wiring 70 is bonded to the bottom face of the first cymbal 11. Like the first vibration sensor 41, an elastic member such as rubber may be interposed between the second vibration sensor 44 and the first cymbal 11.

Note here that the first vibration sensor 41, the touch sensor 43, the distance sensor 42, and the second vibration sensor 44 are electrically connected to the connector 57 via the substrate 40.

### Second Cymbal Unit

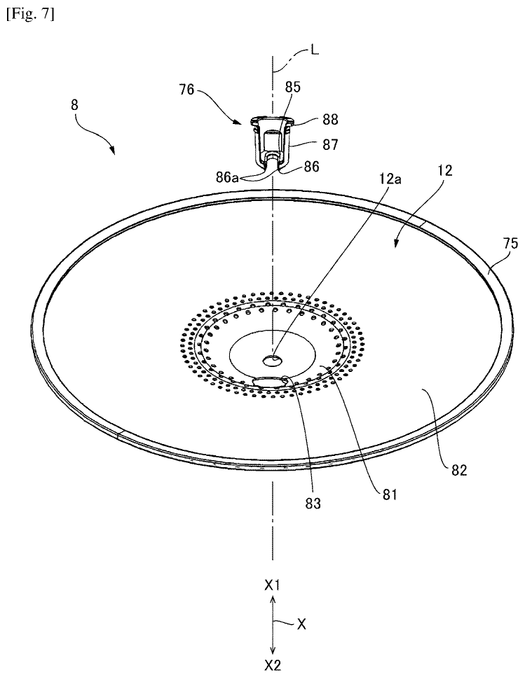

FIG. 7 is an exploded perspective view of the second cymbal unit 8. As illustrated in FIG. 3 and FIG. 4, the second cymbal unit 8 includes the second cymbal 12, a shock absorbing member 75, and a cable guide 76.

The second cymbal 12 includes, in the center thereof, a dome-shaped part 81 protruding downward. Furthermore, the second cymbal 12 includes, on the outer periphery side of the center part, an annular tapered part 82 extending to the upper side X1 toward the outer periphery side. Furthermore, the second cymbal 12 includes a wiring hole 83 opened through in the top-and-bottom direction X in a part of the dome-shaped part 81 in the circumferential direction, which is closer to the tapered part 82 than to the center hole 12a.

As illustrated in FIG. 7, the shock absorbing member 75 is attached to the outer peripheral edge of the second cymbal 12. As a result, the outer peripheral edge of the top face of the second cymbal 12 is covered with the shock absorbing member 75. In the present embodiment, the shock absorbing member 75 is made of, or comprises, rubber. The shock absorbing member 75 is in an annular shape, and its cross section is in a rectangular shape. The shock absorbing member 75 has a groove extending toward the circumferential direction, in the center in the top-and-bottom direction X of the face facing the inner side of the radial direction. The shock absorbing member 75 is attached to the second cymbal 12 by inserting the outer peripheral edge of the second cymbal 12 into the groove. Note that the shock absorbing member 75 may be a gel-like member. A ring-shaped rubber or gel-like material may be attached to the outer peripheral edge of the top face of the second cymbal 12.

As illustrated in FIG. 4, the cable guide 76 is fixed to the wiring hole 83 while being inserted through the wiring hole 83. As illustrated in FIG. 7, the cable guide 76 includes: a curved plate part 85 that is curved in a C-shaped form when viewed from the top-and-bottom direction X; a lower curved wall part 86 extending to the lower side X2 from the inner peripheral edge of the curved plate part 85; an upper curved wall part 87 extending to the upper side X1 from the outer peripheral edge of the curved plate part 85; and a flange part 88 spreading toward the outer periphery side from the upper edge of the upper curved wall part 87. The cable guide 76 is inserted into the wiring hole 83 from the upper side X1 in an orientation with the released parts of the curved plate part 85, the lower curved wall part 86, and the upper curved wall part 87 facing the outer side of the radial direction. When the cable guide 76 is inserted into the wiring hole 83 and fixed to the second cymbal 12, the flange part 88 abuts against the opening edge of the wiring hole 83 on the top face of the second cymbal 12. The upper curved wall part 87 protrudes toward the lower side X2 from the second cymbal 12 through the wiring hole 83. The lower curved wall part 86 is disposed at a position away from the second cymbal 12 toward the lower side X2.

### Module

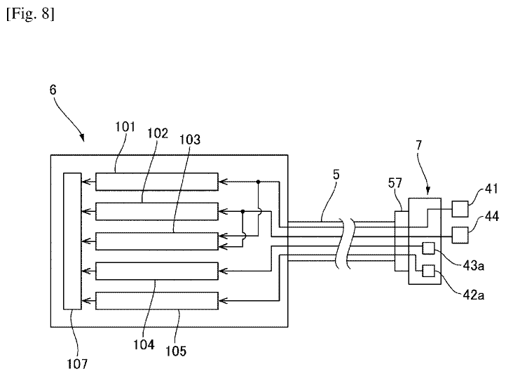

FIG. 8 is a schematic block diagram illustrating the control system of the electronic hi-hat cymbals 1. As illustrated in FIG. 8, the module 6 includes: an attack signal generation unit 101 that generates an attack signal indicating the striking time point based on the output from the first vibration sensor 41; a dynamic signal generation unit 102 that generates a dynamic signal indicating the intensity of striking based on the output from the second vibration sensor 44; and a striking position signal generation unit 103 that generates a striking position signal indicating the striking position on the first cymbal 11 based on the output from the first vibration sensor 41 and the output from the second vibration sensor 44. The module 6 also includes: a mute signal generation unit 104 that generates a mute signal indicating mute based on the output from the touch sensor 43; and an isolated distance signal generation unit 105 that generates an isolated distance signal indicating the isolated distance based on the output from the distance sensor 42. In addition, the module 6 includes an output unit 107 for outputting the attack signal, the dynamic signal, the striking position signals, the mute signal, and the isolated distance signal to the outside. The signals from the output unit 107 of the module 6 are input to a sound source device.

### Electronic Hi-Hat Cymbals

When supporting the electronic instrument 4 on the hi-hat stand 2, the second cymbal 12 with the shock absorbing member 75 is first supported on the second support part 22. Then, the cable 5 is routed from the lower side X2 of the second cymbal 12 to the upper side X1 via the wiring hole 83 of the second cymbal 12. As illustrated in FIG. 4, the cable 5 includes, on the upper end part thereof, a cable-side connector 90 that can be attached to and detached from the connector 57.

Next, the cable guide 76 is attached to the underside of the cable-side connector 90 in the cable 5. In this case, the cable 5 is inserted onto the inner sides of the curved plate part 85, the lower curved wall part 86, the upper curved wall part 87, and the flange part 88 from the released parts of the curved plate part 85, the lower curved wall part 86, the upper curved wall part 87, and the flange part 88 of the cable guide 76.

The cable guide 76 is fixed to the second cymbal 12 with the flange part 88 being abutted against the top face of the second cymbal 12. As illustrated in FIG. 3, when the cable guide 76 is being fixed to the second cymbal 12, the upper curved wall part 87 protrudes to the lower side X2 from the second cymbal 12 through the wiring hole 83. The lower curved wall part 86 is disposed at a position away from the second cymbal 12 toward the lower side X2. Thus, the lower curved wall part 86 comes to have a pair of opposing parts 86a facing the cable 5 from both sides of the circumferential direction at the positions away from the second cymbal 12 to the lower side X2. Note here that the inner diameter of the lower curved wall part 86 is slightly larger than the outer diameter of the cable 5, and the cable guide 76 allows the cable 5 to move in the top-and-bottom direction X. The upper curved wall part 87 is in a size capable of receiving the cable-side connector 90 from upper side X1.

Next, as illustrated in FIG. 4, the cable-side connector 90 is mounted to the connector 57 from the opening part 52a of the first holder 31. Thereby, the first vibration sensor 41, the touch sensor 43, the distance sensor 42, and the second the vibration sensor 44 provided to the first cymbal unit 7 are electrically connected to the cable 5. Thereafter, the first cymbal 11 is supported on the first support part 21. When the first cymbal 11 is supported by the first support part 21 of the hi-hat stand 2, the extension rod 24 is inserted through the cylindrical part 50 of the first holder 31 in the top-and-bottom direction X, which is fitted into the center hole 11a of the first cymbal 11. Note that the order of connecting the cable 5 to the connector 57 and supporting the first cymbal 11 on the first support part 21 may be reversed.

The first cymbal 11 is supported by the first support part 21 of the hi-hat stand 2 and the second cymbal 12 is supported by the second support part 22 to form the electronic hi-hat cymbals 1.

Next, the first cymbal 11 and the second cymbal 12 are rotated relative to each other around the axis line, so that the wiring hole 83 in the first holder 31 and the wiring hole 83 in the second cymbal 12 overlap with each other when viewed from the top-and-bottom direction X. In this state, the cable 5 is pulled downward, with the cable 5 extending in a straight line toward the second cymbal 12 from the first holder 31. Thereafter, as illustrated in FIG. 1, the cable 5 is connected to the module 6. The cable 5 inserted through the second cymbal 12 to the lower side X2 is connected to the module 6 after being routed around while being in contact with the floor face or the like

Here, when the first cymbal 11 supported by the hi-hat stand 2 is to rotate in the circumferential direction, the pair of opposing parts 86a of the cable guide 76 interfere with the cable 5 from the circumferential direction to restrict the relative rotation of the first cymbal 11 and the second cymbal 12. Furthermore, since the cable 5 inserted through the second cymbal 12 and extending toward the lower side X2 is routed around while being in contact with the floor face or the like, the movement of the cable 5 itself is restricted by the floor face. As a result, the first cymbal 11 and the second cymbal 12 are prevented from rotating excessively. By preventing or suppressing excessive rotation of the first cymbal 11 by striking, it is possible to prevent or suppress excessive displacement of the position of the vibration sensor attached to the first cymbal 11 in the circumferential direction. This makes it possible to suppress an excessive change in the level of the signals from the vibration sensor due to an excessive change in the distance between the striking position of the performer and the first vibration sensor 41 and the second vibration sensor 44 due to the rotation of the first cymbal 11.

Furthermore, in the electronic hi-hat cymbals 1, the first cymbal 11 supported by the first support part 21 is lifted up and down by operating the pedal part 27 of the lifting mechanism 23. Note here that the distance sensor 42 is supported at a position away from the first cymbal 11 toward the lower side X2 by the first holder 31 fixed on the underside of the first cymbal 11. Therefore, the coil 42a moves in the top-and-bottom direction X together with the first cymbal 11 on the lower side X2 than the first cymbal 11.

### Operational Effect

The electronic instrument 4 of the present embodiment includes the first cymbal 11 made of, or comprising, metal. Thus, when striking the first cymbal 11, the performer can have the same sense of playing as when striking the actual cymbal. The electronic instrument 4 also includes the capacitance-type touch sensor 43 (e.g., a capacitive touch sensor), and the first cymbal 11 is used as the touch electrode of the touch sensor 43. Thus, when the performer with capacitance touches the first cymbal 11, the line-to-ground capacitance of the first cymbal 11 changes, and a signal corresponding to the change in line-to-ground capacitance is output from the touch sensor 43. Therefore, when the performer touches the first cymbal 11 in the same manner as when muting the actual cymbal, a signal indicating mute can be output from the touch sensor 43. This eliminates the need for the performer to check the area the performer is required to touch, when muting the first cymbal 11. Therefore, when muting the first cymbal 11, it is possible to prevent or suppress the loss of the sense of playing for the performer who is playing the electronic instrument 4.

The first cymbal unit 7 includes: the first vibration sensor 41 that detects the vibration of the first cymbal 11; and the second vibration sensor 44 that detects vibration of the first cymbal 11 on the outer periphery side of the first vibration sensor 41. The first vibration sensor 41 overlaps with the bell 35 of the first cymbal 11 when viewed from the top-and-bottom direction X, and the second vibration sensor 44 overlaps with the part of the bow 37 of the first cymbal 11 closer to the edge 36 than to the bell 35. Thus, the electronic instrument 4 includes the two vibration sensors at different positions in the radial direction of the first cymbal 11. Therefore, it is easy to acquire the striking point position on the first cymbal 11 based on the signals output from each of the two vibration sensors.

Furthermore, the first cymbal unit 7 includes: the substrate 40 on which the circuit part 43a of the touch sensor 43 is formed; the resin first holder 31 that supports the substrate 40 and the first vibration sensor 41; and the headed screws 32 for fixing the first holder 31 to the bottom face of the first cymbal 11. The first cymbal 11 has the center hole 11a. The first holder 31 includes: the cylindrical part 50 inserted into the center hole 11a; and the first bosses 58a arranged in an annular form on the outer periphery side of the cylindrical part 50. The outer peripheral face of the cylindrical part 50 contacts the inner wall face of the center hole 11a in the first cymbal 11. The first holder 31 is fixed to the first cymbal 11 by screwing each of the headed screws 32 through the first cymbal 11 from the upper side X1 to the lower side X2 into the screw holes of each of the second bosses 58b. The second bosses 58b encircle the bell 35 on the outer periphery side, when the first holder 31 is fixed to the first cymbal 11. As a result, the first holder 31 is fixed to the first cymbal 11 while being in contact with the opening edge of the center hole 11a of the first cymbal 11 and the outer periphery side of the bell 35. Thus, when the first cymbal 11 is struck, the first holder 31 functions as the damper for attenuating the vibration of the bell 35 at an early stage. Since the first cymbal 11 is made of, or comprises, metal, the vibration caused by striking is prone to generate undulation, and the amplitude repeatedly increases and decreases. Therefore, there is an issue that the striking time point, which is the time point of maximum amplitude, tends to be mis-detected. For such an issue, the first holder 31 functions as the damper for attenuating the vibration of the bell 35 at an early stage. Thus, in the present embodiment, it is easy to acquire the striking time point based on the signal from the first vibration sensor 41.

In the present embodiment, the first holder 31 includes the first bosses 58a and the second bosses 58b arranged in an annular form at different positions in the radial direction. When fixing the first holder 31 to the first cymbal 11, the bosses 58 into which the headed screws 32 are screwed can be selected between the first bosses 58a and the second bosses 58b. Therefore, as the first cymbal 11, when there are two types of first cymbals 11 with different sizes in the radial direction, for example, it is possible to share a single first holder 31 by those two types of first cymbals 11. Even in a case where a single first holder 31 is shared between two different types of first cymbals 11 with different sizes in the radial direction, the bosses 58 for screwing the headed screws 32 can be positioned on the outer periphery side of the bell 35.

In the electronic hi-hat cymbals 1, the isolated distance between the first cymbal 11 and the second cymbal 12 changes by operating the pedal. Therefore, in order to reproduce the striking sound, it is necessary to have the distance sensor 42 that outputs a signal to acquire the isolated distance between the first cymbal 11 and the second cymbal 12. On the contrary, in the present embodiment, the first cymbal unit 7 includes the distance sensor 42 that is supported by the first holder 31 and outputs a signal corresponding to the isolated distance between the first cymbal 11 and the second cymbal 12 in the top-and-bottom direction X. The distance sensor 42 is an oscillation-type proximity sensor that includes an oscillation circuit having the coil 42a with the opening facing toward the top-and-bottom direction X and outputs a signal oscillated by the oscillation circuit. Note here that the second cymbal 12 is made of, or comprises, metal exhibiting electrical conductivity. Thus, the frequency and amplitude of the signal oscillated by the oscillation circuit vary by corresponding to the isolated distance between the first cymbal 11 and the second cymbal 12. Therefore, it is possible to output a signal corresponding to the isolated distance between the first cymbal 11 and the second cymbal 12 from the distance sensor 42. Furthermore, the coil 42a is positioned in the lower side X2 than the edge 36 of the first cymbal 11. In other words, the first holder 31 supports the coil 42a at a position away from the first cymbal 11 toward the lower side X2. This allows the isolated distance between the first cymbal 11 and the second cymbal 12 to be detected with high accuracy.

Furthermore, the second cymbal 12 has a smaller outer diameter than that of the first cymbal 11, and the outer peripheral edge of the top face of the second cymbal 12 is covered with the shock absorbing member 75. Therefore, when the first cymbal 11 made of, or comprising, metal and the second cymbal 12 made of, or comprising, metal come in contact with each other, it is possible to prevent or suppress the first cymbal 11 from being scratched. Since the outer periphery edge of the top face of the second cymbal 12 is covered with the shock absorbing member 75, the fluttering sound generated when the first cymbal 11 and the second cymbal 12 are played with an opening that allows a contact therebetween is not transmitted to the first vibration sensor and the second vibration sensor.

Furthermore, the electronic hi-hat cymbals 1 of the present embodiment include the module 6 connected to the electronic instrument 4 via the cable 5. The module 6 generates an attack signal indicating the striking time point based on the output from the first vibration sensor 41. The module 6 also generates a dynamic signal indicating the intensity of striking based on the signal from the second vibration sensor 44.

Since the first cymbal 11 is made of, or comprises, metal, the vibration caused by striking is prone to generate undulation, and the amplitude repeatedly increases and decreases. Therefore, there is an issue that the attack signal with the time point of maximum amplitude being the striking time point tends to be mis-detected. For such an issue, the signal from the first vibration sensor 41 disposed in a position overlapping with the bell 35 of the first cymbal 11 has fewer low-frequency band components than the signal from the second vibration sensor 44 disposed in a position overlapping with the bow 37, and its amplitude tends to be attenuated over time. The amplitude of the vibration of the bell 35 is easily attenuated by the first holder 31, which is fixed to the first cymbal 11. Therefore, by acquiring the attack signal based on the signal from the first vibration sensor 41, it is possible to prevent or suppress the attack signal generation unit 101 from mis-detecting the attack signal.

Furthermore, the signal from the second vibration sensor 44 disposed in the position overlapping with the bow 37 has more low-frequency band components than the signal from the first vibration sensor 41 disposed at the position overlapping with the bell 35, so that it is easier to acquire the amplitude of the vibration corresponding to the intensity of striking. Therefore, the dynamic signal generation unit 102 can easily generate a dynamic signal indicating the intensity of striking based on the signal from the second vibration sensor 44.

In addition, the module 6 includes the output unit 107 for outputting the attack signal, the dynamic signal, the striking position signal, the mute signal, and the isolated distance signal generated based on the output from each of the sensors of the electronic instrument 4. Therefore, by inputting the signal from the output unit 107 of the module 6 to the sound source device, it is possible to generate the striking sound corresponding to the striking of the electronic instrument 4 from the sound source device.

### Other Embodiments

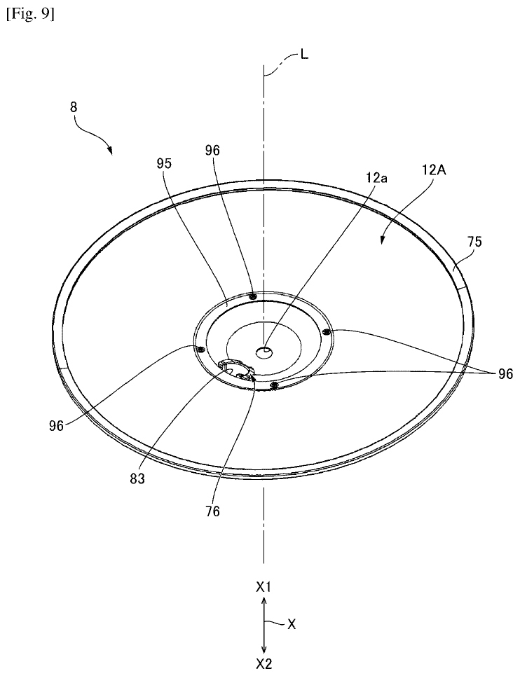

FIG. 9 is a perspective view of the second cymbal unit 8 when viewed from the upper side X1, in a case where the second cymbal 12 is made of, or comprises, resin. A second cymbal 12A of a present embodiment is made of, or comprises, a non-conductive material (e.g., electrically insulating material) such as resin, for example. Since the second cymbal 12A has a configuration corresponding to that of the second cymbal 12, the same reference signs are applied to the corresponding parts and the explanations thereof are omitted.

When the second cymbal 12A is made of, or comprises, resin, the second cymbal unit 8 includes a conductive metal member 95 fixed to the second cymbal 12A, as illustrated in FIG. 9. In the example illustrated in FIG. 9, the metal member 95 is in an annular form. The metal member 95 is fixed to the boundary between the dome-shaped part 81 and the tapered part 82 of the second cymbal 12A via conductive headed screws 96. The metal member 95 is disposed coaxially with the coil 42a of the distance sensor 42 provided to the first cymbal unit 7. Furthermore, when viewed from the top-and-bottom direction X, the metal member 95 overlaps with the coil 42a of the distance sensor 42.

In this manner, it is also possible to output a signal corresponding to the isolated distance between the first cymbal 11 and the second cymbal 12A from the distance sensor 42. Also in the present embodiment, the coil 42a, which configures the oscillation circuit of the distance sensor 42, is positioned on the lower side X2 than the edge 36 of the first cymbal 11. In other words, the first holder 31 supports the coil 42a at a position away from the first cymbal 11 toward the lower side X2. This allows the isolated distance between the first cymbal 11 and the second cymbal 12A to be detected with high accuracy. When the second cymbal 12A is made of, or comprises, resin, the shock absorbing member 75 may be omitted.

The first cymbal unit 7 may include, in the circumferential direction, a plurality of first vibration sensors 41 disposed in positions overlapping with the bell 35. The first cymbal unit 7 may also include, in the circumferential direction, a plurality of second vibration sensors 44 disposed in positions overlapping with the bow 37. Furthermore, the first cymbal unit 7 may include, in the radial direction, a plurality of second vibration sensors 44 disposed in positions overlapping with the bow 37.

Furthermore, among the first bosses 58a and the second bosses 58b, the first holder 31 may include only one of the bosses 58 corresponding to the size of the first cymbal 11 to be employed.

Moreover, only the first cymbal unit 7 may be supported on the cymbal stand and used as an electronic instrument 4. In this case, the distance sensor 42 of the first cymbal unit 7 can be omitted.

### Second Embodiment

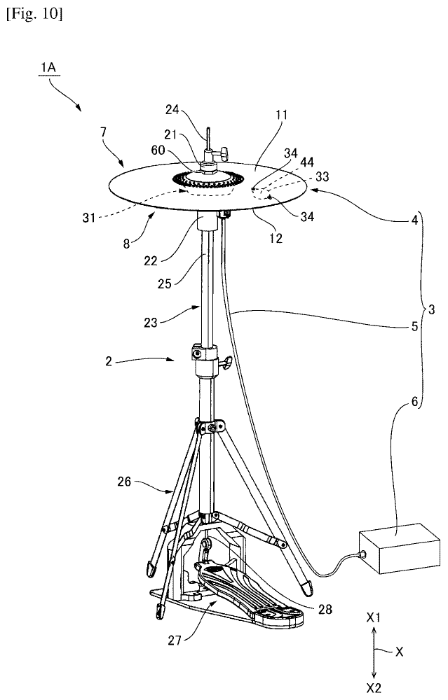

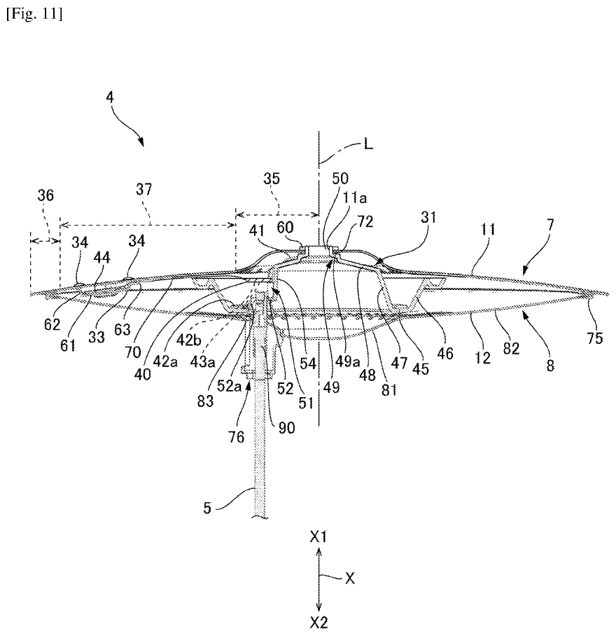

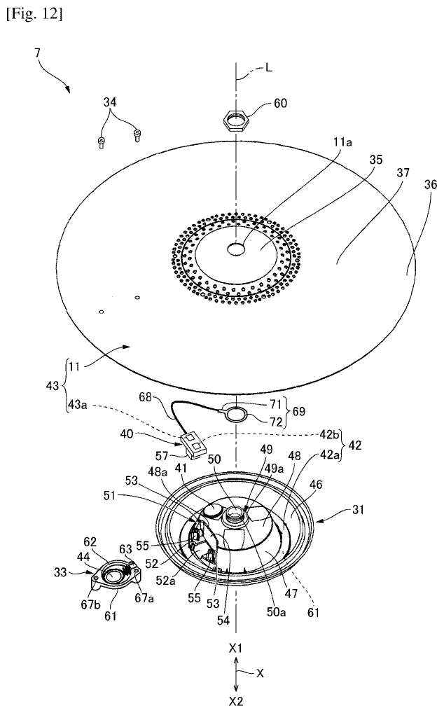

FIG. 10 is an explanatory diagram of electronic hi-hat cymbals according to a second embodiment. FIG. 11 is a sectional view of an electronic cymbal of FIG. 10. FIG. 12 is an exploded perspective view of a first cymbal unit of FIG. 10. Electronic hi-hat cymbals 1A of the present embodiment include an electronic instrument 4 supported on a commercially available hi-hat stand 2 and a module 6 (control unit) electrically connected to the electronic instrument 4 via a cable 5. The electronic instrument 4, the cable 5, and the module 6 configure an electronic cymbal set 3. In the present embodiment, the electronic instrument 4 includes a first cymbal unit 7 and a second cymbal unit 8.

The electronic hi-hat cymbals 1A of the present embodiment are the same as the electronic hi-hat cymbals 1 except for the first cymbal unit 7. Therefore, the first cymbal unit 7 will be described, and other explanations will be omitted. The electronic hi-hat cymbals 1A of the present embodiment have a configuration corresponding to the electronic hi-hat cymbals 1 described above. Therefore, the same reference signs are applied to the corresponding structures, and detailed explanations thereof are omitted.

### First Cymbal Unit

As illustrated in FIG. 10, the first cymbal unit 7 includes a first cymbal 11 made of, or comprising, metal, a first holder 31 (holder) attached to the bottom face of the first cymbal 11, and a second holder 33 (second holder). The first holder 31 is fixed to the underside of the first cymbal 11 by a nut 60. The second holder 33 is fixed to the bottom face of the first cymbal 11 by two headed screws (second headed screws). Furthermore, as illustrated in FIG. 12, the first cymbal unit 7 includes a substrate 40, a first vibration sensor 41, a touch sensor 43, a distance sensor 42, and a second vibration sensor 44.

### First Cymbal

As illustrated in FIG. 10, the center part of the first cymbal 11 is positioned on the upper side X1 compared to the outer peripheral edge. The first cymbal 11 may have a great number of small holes 15 opened through in the top-and-bottom direction X on the entire surface to suppress the volume of the striking sound when the first cymbal 11 is struck. As illustrated in FIG. 11, the first cymbal 11 includes a bell 35, a bow 37, and an edge 36 in this order from the center toward the outer periphery side. The center of the bell 35, that is, the center of the first cymbal 11, is provided with a center hole 11a where an extension rod 24 goes through when supported by the hi-hat stand 2.

As illustrated in FIG. 12, the first holder 31 is in an annular form. As illustrated in FIG. 11, the first holder 31 holds the substrate 40, the first vibration sensor 41, and a coil 42a of the distance sensor 42. A circuit part 42b of the distance sensor 42 and a circuit part 43a for the touch sensor 43 are formed on the substrate 40. The second holder 33 holds the second vibration sensor 44 that detects the vibration of the first cymbal 11 on the outer periphery side of the first vibration sensor 41.

### First Holder

The first holder 31 is made of, or comprises, resin. The first holder 31 includes: an annular plate part 45 perpendicular to the center axis line L of the first cymbal 11; an outer tapered plate part 46 sloping upward to the upper side X1 from the edge on the outer periphery side of the annular plate part 45 toward the outer periphery side; an inner tapered plate part 47 sloping upward to the upper side X1 from the edge on the inner periphery side of the annular plate part 45 toward the inner periphery side; and an annular center plate part 48 sloping toward the inner periphery side from the upper edge of the inner tapered plate part 47 toward the upper side X1. The center plate part 48 is provided with: an annular protrusion part 49 protruding toward the upper side X1 at its center part; and a circular cylindrical part 50 extending toward the upper side X1 from the opening edge of the center hole 11a in the protrusion part 49.

The cylindrical part 50 has a male thread 50a on its outer peripheral face. The male thread 50a can be engaged with the nut 60. An annular plate part 49a, which regulates the top face of the protrusion part 49, spreads from the lower end of the cylindrical part 50 to the outer periphery side.

As illustrated in FIG. 12, a recessed part 51 recessed onto the inner periphery side is provided in a part of the inner tapered plate part 47 in the circumferential direction. Furthermore, a notch part 48a recessed onto the inner periphery side by corresponding to the recessed part 51 is provided in a part of the center plate part 48 in the circumferential direction. The recessed part 51 includes: a bottom plate part 52 extending in a direction orthogonal to the center axis line L; a pair of side plate parts 53 extending toward the upper side X1 from both edges of the bottom plate part 52 in the circumferential direction; and a connection plate part 54 that extends in the circumferential direction and connects the edges of the pair of side plate parts 53 on the inner periphery side. The center plate part 48 continues from the upper edges of each of the side plate parts 53 to the upper edge of the connection plate part 54.

An opening part 52a is provided in the center part of the bottom plate part 52 in the circumferential direction. A substrate fixation part 55 is provided in each of both sides of the opening part 52a in the circumferential direction in the bottom plate part 52. The substrate 40 is fixed to a pair of substrate fixation parts 55 from the upper side X1. Note here that a connector 57 is attached to the bottom face of the substrate 40. With the substrate 40 being fixed to the pair of substrate fixation parts 55, the connector 57 can be visually recognized from the lower side X2 of the first holder 31 through the opening part 52a.

As illustrated in FIG. 11 and FIG. 12, the first vibration sensor 41 is placed on the center plate part 48 of the first holder 31. The first vibration sensor 41 overlaps with the bell 35, when viewed from the top-and-bottom direction X. The first vibration sensor 41 is placed on the center plate part 48 via a sheet-like first elastic member 65. Furthermore, the first vibration sensor 41 comes in contact with the bottom face of the bell 35 via the sheet-like second clastic member 66 (see FIG. 6). The first vibration sensor 41 is connected to the substrate 40 via a lead wire, not illustrated.

The touch sensor 43 includes the circuit part 43a provided on the substrate 40, and a touch electrode. The touch electrode is the first cymbal 11. For allowing the first cymbal 11 to be a touch electrode, the first cymbal unit 7 includes a lead wire 68 that electrically connects the substrate 40 to the first cymbal 11, and a conductive terminal 69 (conductive member). The terminal 69 includes a connection unit 71 to which the lead wire 68 is connected, and an annular part 72. Note here that the whole part of the annular plate part 49a that regulates the top face of the protrusion part 49 is a mount part on which the annular part 72 is placed. As illustrated in FIG. 11, the annular part 72 is placed on the annular plate part 49a with the cylindrical part 50 of the first holder 31 being inserted in its center hole thereof.

The coil 42a of the distance sensor 42 is fixed to the annular plate part 45 of the first holder 31 in an orientation with the opening facing the top-and-bottom direction X. The coil 42a encircles the inner tapered plate part 47. The circuit part 42b of the distance sensor 42 is provided on the substrate 40.

When fixing the first holder 31 to the first cymbal 11, the annular part 72 of the terminal 69 is placed on the annular plate part 49a and the cylindrical part 50 is inserted into the center hole 11a of the first cymbal 11. This causes the upper end part of the cylindrical part 50 to protrude toward the upper side X1 from the first cymbal 11. Thus, the male thread 50a provided in the cylindrical part 50 is exposed to the upper side X1 of the first cymbal 11. The outer peripheral face of the cylindrical part 50 contacts the inner wall of the center hole 11a in the first cymbal 11. The annular part 72 of the terminal 69 is positioned between the protrusion part 49 and the first cymbal 11 on the outer periphery side of the cylindrical part 50.

Next, from the upper side X1 of the first cymbal 11, the nut 60 is screwed onto the male thread 50a of the cylindrical part 50. Thereby, the first holder 31 is fixed to the first cymbal 11. Here, when the first holder 31 is being fixed to the first cymbal 11, the annular part 72 of the terminal 69 is sandwiched between the annular plate part 49a of the protrusion part 49 and the opening edge of the center hole 11a on the bottom face of the first cymbal 11. As a result, the circuit part 43a is electrically connected to the first cymbal 11 via the lead wire 68 and the terminal 69.

Furthermore, when the first holder 31 is being fixed to the first cymbal 11, the annular plate part 45 of the first holder 31 is positioned on the lower side X2 than the edge 36 of the first cymbal 11. Therefore, the coil 42a of the distance sensor 42 is positioned on the lower side X2 than the edge 36 of the first cymbal 11. In other words, the first holder 31 supports the coil 42a at a position away from the first cymbal 11 toward the lower side X2.

Furthermore, when the first holder 31 is fixed to the first cymbal 11, the upper end of the outer tapered plate part 46 does not come in contact with the first cymbal 11. In other words, on the further outer periphery side than the annular plate part 45, the first holder 31 has no part that comes in contact with the first cymbal 11.

### Second Holder

As illustrated in FIG. 11 and FIG. 12, the second holder 33 holds the second vibration sensor 44. As illustrated in FIG. 12, the second holder 33 includes: a circular sensor support part 61; a frame part 62 extending upward to the upper side X1 from the outer peripheral edge of the sensor support part 61; and a wiring lead-out part 63 extending to the outer side in the radial direction by notching a part of the frame part 62 in the circumferential direction. The second vibration sensor 44 is supported on the sensor support part 61. Furthermore, the second holder has a first screw hole 67a on one side of the second vibration sensor 44 in the frame part 62, and a second screw hole 67b on the other side.

The second holder 33 is fixed to the bottom face of the first cymbal 11 by two headed screws 34 that are screwed into each of the first screw hole 67a and the second screw hole 67b by being inserted through the first cymbal 11. When the second holder 33 is fixed to the first cymbal 11, the two headed screws 34 screwed into each of the screw holes 67a and 67b are arranged in the radial direction of the first cymbal 11, as illustrated in FIG. 10 and FIG. 11.

Furthermore, with the second holder 33 being fixed to the first cymbal 11, the second vibration sensor 44 overlaps with a part of the bow 37 closer to the edge 36 than to the bell 35. Furthermore, the second vibration sensor 44 opposes to the bow 37 with a gap provided therebetween. The second vibration sensor 44 is connected to the substrate 40 by a wiring 70 led out through the wiring lead-out part 63.

### Operational Effect

The present embodiment includes: the nut 60 for fixing the first holder 31 to the first cymbal 11; the lead wire 68 that electrically connects the circuit part 43a of the touch sensor 43 to the first cymbal 11; and the terminal 69 connected to the lead wire 68. The first holder 31 includes the annular plate part 49a spreading to the outer periphery side from the lower end of the cylindrical part 50, and the male thread 50a provided on the outer peripheral face of the cylindrical part 50. The annular plate part 49a is a mount part on which the conductive member is placed. On the further outer periphery side than the annular plate part 49a, the first holder 31 has no part that comes in contact with the first cymbal 11. Thus, the first holder 31 is fixed to the first cymbal 11 at a position close to the center of the first cymbal 11. Thereby, the sound generated when the first cymbal 11 is struck becomes closer to that of the actual cymbal when struck, compared to the case where the bosses 58 for fixing the first holder 31 to the first cymbal 11 encircle the bell 35 on the outer periphery side of the bell 35. Thus, the sense of playing when the performer strikes the first cymbal 11 can be made closer to the sense of playing when striking a conventional cymbal.

On the other hand, the first holder 31 is fixed to the first cymbal 11 by the nut 60 screwed onto the male thread 50a of the cylindrical part 50 protruding toward the upper side X1 from the first cymbal 11. Note here that the contact area where the nut 60 contacts the surface of the first cymbal 11 is relatively large. Thus, the first holder 31 fixed to the first cymbal 11 by the nut 60 functions as the damper for attenuating the vibration of the bell 35 at an early stage. Since the first cymbal 11 is made of, or comprises, metal, the vibration caused by striking is prone to generate undulation, and the amplitude repeatedly increases and decreases. Therefore, there is an issue that the striking time point, which is the time point of maximum amplitude, tends to be mis-detected. For such an issue, when the first holder 31 functions as the damper for attenuating the vibration of the bell 35 at an early stage, it becomes easy to acquire the striking time point based on the signal from the first vibration sensor 41.

Furthermore, by screwing the nut 60 onto the cylindrical part 50 of the first holder 31, the terminal 69 is sandwiched between the first cymbal 11 and the annular plate part 49a. Thereby, the circuit part 42b of the touch sensor 43a is connected to the first cymbal 11 via the lead wire 68 and the terminal 69. This makes it easy to use the first cymbal 11 as the touch electrode for the touch sensor 43.

Furthermore, the second holder 33 has the first screw hole 67a on one side of the second vibration sensor 44 in the frame part 62 and the second screw hole 67b on the other side. The second holder 33 is fixed to the bottom face of the first cymbal 11 by the two headed screws 34 that are screwed into the first screw hole 67a and the second screw hole 67b by being inserted through the first cymbal 11. When the second holder 33 is fixed to the first cymbal 11, the two headed screws 34 screwed into each of the screw holes 67a and 67b are arranged in the radial direction of the first cymbal 11. Therefore, it becomes easier to detect the vibration of the first cymbal 11 by the second vibration sensor 44. In other words, when the first cymbal 11 is struck, the vibration is propagated in the circumferential direction as the undulation of the bow 37. Therefore, in a case where the two headed screws 34 are arranged in the circumferential direction of the first cymbal 11 when the second holder 33 is fixed to the first cymbal 11, the undulation of the bow 37 tends to be inhibited by the two headed screws 34 and the second holder 33, and the amplitude of the vibration caused by striking tends to become small. On the contrary, when the two headed screws 34 for fixing the second holder 33 are arranged in the radial direction of the first cymbal 11, the undulation of the bow propagating in the circumferential direction can be prevented from being hindered by the two headed screws 34 and the second holder 33. Thus, it is possible to suppress reduction in the amplitude of the vibration caused by striking. Therefore, it becomes easier to acquire the amplitude of the vibration corresponding to the strength of the striking by the second vibration sensor 44.

With the configuration of the present embodiment in which the first holder 31 is fixed to the first cymbal 11 by screwing the nut 60 onto the male thread 50a of the cylindrical part 50 protruding toward the upper side X1 from the center hole 11a of the first cymbal 11, in a case where, as the first cymbal 11, there are a plurality of types of first cymbals with different sizes in the radial direction, or the like, it is possible to share a single first holder 31 by those types of first cymbals.

Furthermore, since the electronic hi-hat cymbals 1A of the present embodiment has the configuration corresponding to the electronic hi-hat cymbals 1 of the first embodiment, the same effect as that of the electronic hi-hat cymbals 1 can be achieved based on the corresponding configuration.

Note here that configuration in which the two headed screws 34 screwed into each of the screw holes 67a and 67b are arranged in the radial direction of the first cymbal 11 when the second holder 33 is fixed to the first cymbal 11 may also be employed for the electronic hi-hat cymbals 1 of the first embodiment.

Furthermore, the terminal 69 can be in any shape as long as it can be inserted between the first cymbal 11 and the mount part of the first holder 31. The second holder 33 may be fixed to the first cymbal by a single headed screw.

### Third Embodiment

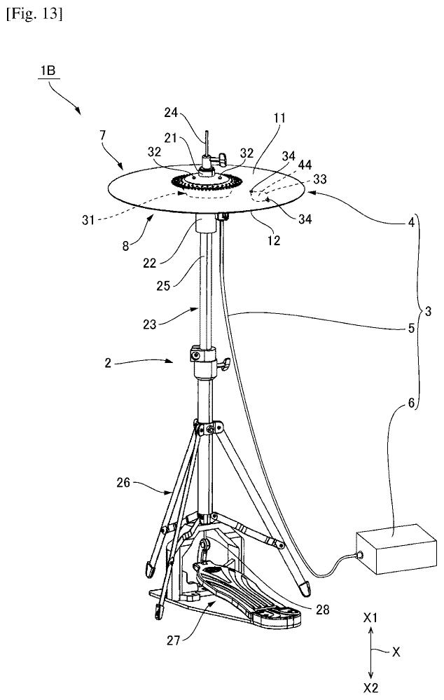

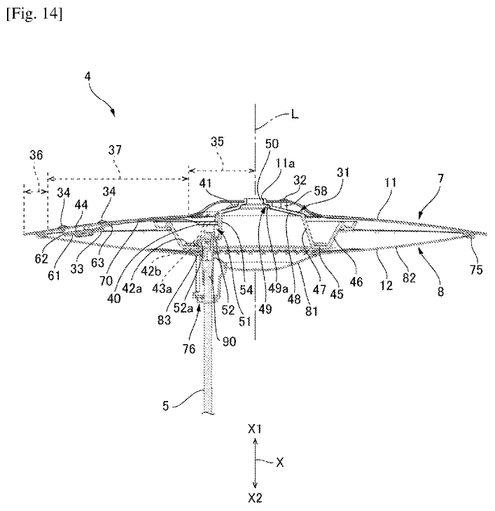

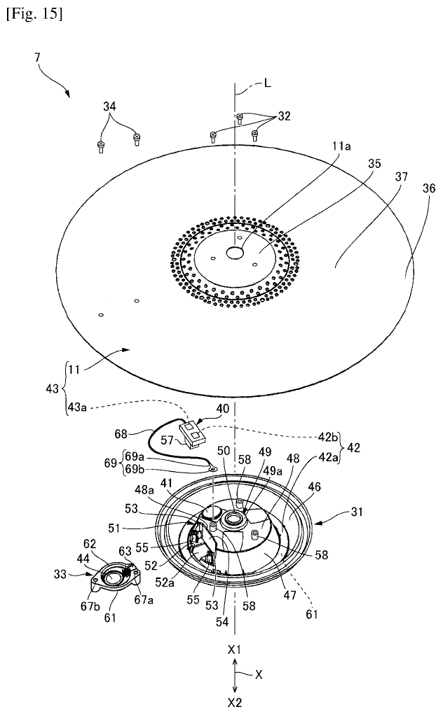

FIG. 13 is an explanatory diagram of electronic hi-hat cymbals of a third embodiment. FIG. 14 is a sectional view of an electronic cymbal of FIG. 13. FIG. 15 is an exploded perspective view of a first cymbal unit of FIG. 13. Electronic hi-hat cymbals 1B of the present embodiment include an electronic instrument 4 supported on a commercially available hi-hat stand 2, and a module 6 (control device) electrically connected to the electronic instrument 4 via a cable 5. The electronic instrument 4, the cable 5, and the module 6 configure an electronic cymbal set 3. The electronic instrument 4 includes a first cymbal unit 7 and a second cymbal unit 8.

The electronic hi-hat cymbals 1B of the present embodiment is the same as the electronic hi-hat cymbals 1A of the second embodiment, except for the configuration of fixing the first holder 31 (holder) to the first cymbal 11 and configuration of connecting the first cymbal 11 and the circuit part 43a of the touch sensor 43. Therefore, only the parts that are different will be described, and other explanations will be omitted. Since the electronic hi-hat cymbals 1B of the present embodiment have the configuration corresponding to that of the electronic hi-hat cymbals 1A, the same reference signs are applied to the corresponding elements.

As illustrated in FIG. 13 and FIG. 14, the first holder 31 is attached to the first cymbal 11 by a plurality of headed screws 32 arranged in an annular form. Each of the headed screws 32 is made of, or comprises, metal, and exhibits electrical conductivity. In the present embodiment, there are three headed screws 32.

As illustrated in FIG. 14 and FIG. 15, the first holder 31 includes: an annular plate part 45 perpendicular to the center axis line L of the first cymbal 11; an outer tapered plate part 46 sloping upward to the upper side X1 from the edge on the outer periphery side of the annular plate part 45 toward the outer periphery side; an inner tapered plate part 47 sloping upward to the upper side X1 from the edge on the inner periphery side of the annular plate part 45 toward the inner periphery side; and an annular center plate part 48 sloping to the inner periphery side from the upper edge of the inner tapered plate part 47 toward the upper side X1. A recessed part 51 recessed onto the inner periphery side is provided in a part of the inner tapered plate part 47 in the circumferential direction. Furthermore, a notch part 48a recessed onto the inner periphery side by corresponding to the recessed part 51 is provided in a part of the center plate part 48 in the circumferential direction. The center plate part 48 is provided with: an annular protrusion part 49 protruding toward the upper side X1 at its center part; and a circular cylindrical part 50 extending toward the upper side X1 from the opening edge of a center hole 11a in the protrusion part 49. In the present embodiment, the cylindrical part 50 has no male thread.

A first vibration sensor 41 is placed on the center plate part 48 of the first holder 31. The center plate part 48 has three bosses 58 arranged in an annular form at positions closer to the protrusion part 49 than to the inner tapered plate part 47. Each of the bosses 58 protrudes toward the upper side X1 from the annular plate part 49a. In the top face of each of the bosses 58, a screw hole that can be engaged with the headed screw 32 is provided.

The first holder 31 holds a substrate 40, the first vibration sensor 41, and a coil 42a of a distance sensor 42. The circuit part 42b of the distance sensor 42 and the circuit part 43a of the touch sensor 43 are provided on the substrate 40. For allowing the first cymbal 11 to be the touch electrode, the first cymbal unit 7 includes a lead wire 68 that electrically connects the substrate 40 to the first cymbal 11, and a conductive terminal 69. The terminal 69 includes a connection part 69a to which the lead wire 68 is connected, and a through-hole 69b where the shaft of the headed screw 32 can be inserted.

When fixing the first holder 31 to the first cymbal 11, the cylindrical part 50 of the first holder 31 is fitted into the center hole 11a of the first cymbal 11 from the lower side. As a result, the outer peripheral face of the cylindrical part 50 comes in contact with the inner wall face of the center hole 11a in the first cymbal 11. Furthermore, the top face of the protrusion part 49 of the first holder 31 abuts against the opening edge of the center hole 11a in the first cymbal 11 from the lower side X2. Moreover, each of the bosses 58 provided on the annular plate part 49a encircles the center hole 11a in the bell 35 at a position closer to the center hole 11a than to the bow 37. When fitting the cylindrical part 50 of the first holder 31 into the center hole 11a of the first cymbal 11, the terminal 69 is placed on the top face of a single boss 58 among the three bosses 58. Next, each of the headed screws 32 is inserted through the first cymbal 11 from the upper side X1 to the lower side X2 and screwed into the screw hole of each of the bosses 58. Here, when each of the headed screws 32 is screwed into each of the bosses 58, the shaft of the headed screw 32 is inserted into the through-hole 69b of the terminal 69 in the boss 58 on which the terminal 69 is placed. When the headed screw 32 is then screwed into the boss 58 and the first holder 31 is fixed to the first cymbal 11, the terminal 69 is sandwiched between the top face of the boss 58 and the first cymbal 11, with the headed screw 32 being inserted through the through-hole 69b.

Thereby, the terminal 69 and the first cymbal 11 come in contact and are electrically connected, so that the first cymbal 11 functions as the touch electrode of the touch sensor 43. Furthermore, since the headed screws 32 for fixing the first holder 31 to the first cymbal 11 are conductive, the circuit part 43a of the touch sensor 43 and the first cymbal 11 are electrically connected via the terminal 69 and the headed screws 32. This makes it possible to secure the connection between the circuit part 43a of the touch sensor 43 and the first cymbal 11.

Here, when the first holder 31 is fixed to the first cymbal 11, the first holder 31 has no part that comes in contact with the first cymbal 11 on the further outer periphery side than the bosses 58.

### Operational Effect

In the present embodiment, the bosses 58 for securing the first holder 31 to the first cymbal 11 encircle the center hole 11a in the bell 35 at positions closer to the center hole 11a than to the bow 37 when the first holder 31 is fixed to the first cymbal 11. On the further outer periphery side than the bosses 58, the first holder 31 has no part that comes in contact with the first cymbal 11. Thus, the first holder 31 is fixed to the first cymbal 11 at a position close to the center of the first cymbal 11. Thereby, when the first cymbal 11 is struck, the vibration of the first cymbal 11 can be prevented from being hindered compared to the case where the bosses 58 for fixing the first holder 31 to the first cymbal 11 encircle the bell 35 on the outer periphery side of the bell 35. Thus, the sense of playing when the performer strikes the first cymbal 11 can be made closer to the sense of playing when striking a conventional cymbal.

On the other hand, the first holder 31 comes in contact with the first cymbal 11 at a position close to the center of the first cymbal 11 in the opening edge of the center hole 11a of the first cymbal 11 and the bell 35. Thus, the first holder 31 functions as the damper for attenuating the vibration of the bell 35 at an early stage. Since the first cymbal 11 is made of, or comprises, metal, the vibration caused by striking is prone to generate undulation, and the amplitude repeatedly increases and decreases. Therefore, there is an issue that the striking time point, which is the time point of maximum amplitude, tends to be mis-detected. For such an issue, when the first holder 31 functions as the damper for attenuating the vibration of the bell 35 at an early stage, it becomes easy to acquire the striking time point based on the signal from the first vibration sensor 41.

Furthermore, with the configuration in which the first holder 31 (holder) is fixed to the first cymbal 11 by the headed screws 32 at a position close to the center hole 11a of the first cymbal 11, in a case where, as the first cymbal 11, there are a plurality of types of first cymbals with different sizes in the radial direction, or the like, it is possible to share a single first holder 31 by those types of first cymbals.

Furthermore, since the electronic hi-hat cymbals 1B of the present embodiment have the configuration corresponding to the electronic hi-hat cymbals 1 of the first embodiment and the electronic hi-hat cymbals 1A of the second embodiment, the same effects as those of the electronic hi-hat cymbals 1 and the electronic hi-hat cymbals 1A can be achieved based on the corresponding configuration.

With the configuration in which the first holder 31 (holder) is fixed to the first cymbal 11 by the headed screws 32 at a position close to the center hole 11a of the first cymbal 11, in a case where, as the first cymbal 11, there are two types of first cymbals with different sizes in the radial direction, or the like, it is possible to share a single first holder 31 by the two types of first cymbals.

In the electronic instrument 4 of the first, second, and third embodiments, the second cymbal 12 may have the same outer diameter as that of the first cymbal 11.

1. An electronic instrument comprising:
a first cymbal comprising metal; and
a capacitance-type touch sensor including a touch electrode,
wherein the first cymbal is electrically conductive, and
wherein the touch electrode is the first cymbal.

2. The electronic instrument according to claim 1, comprising:
a first vibration sensor configured to detect a vibration of the first cymbal; and
a second vibration sensor configured to detect a vibration of the first cymbal on an outer periphery side of the first vibration sensor, wherein the first vibration sensor overlaps with a bell of the first cymbal when viewed from a top-and-bottom direction, and
the second vibration sensor is disposed at a position that overlaps with an area in a bow of the first cymbal closer to the bell than to an edge.

4. The electronic instrument according to claim 2, comprising:
a substrate where a circuit part of the touch sensor is formed;
a resin holder that supports the substrate and the first vibration sensor; and
a plurality of headed screws for fixing the holder to a bottom face of the first cymbal, wherein
the first cymbal includes a center hole,
the holder includes a cylindrical part inserted into the center hole, and a plurality of bosses arranged in an annular form on an outer periphery side of the cylindrical part,
an outer peripheral face of the cylindrical part comes in contact with an inner wall face of the center hole of the first cymbal,
a screw hole that is engageable with the headed screw is provided in a top face of each of the bosses, and
the holder is fixed to the first cymbal by having each of the headed screws inserted into the first cymbal from an upper side toward a lower side and screwed into the screw hole of each of the bosses.

4. The electronic instrument according to claim 3, comprising:
a lead wire that electrically connects the circuit part of the touch sensor and the first cymbal; and
a conductive terminal that includes a connection part where the lead wire is connected, and a through-hole where a shaft of the headed screw is able to be inserted, wherein
the headed screw is electrically conductive, and,
when the holder is fixed to the first cymbal, the terminal has the headed screw inserted into the through-hole while being sandwiched between a top face of a single boss among the bosses and the first cymbal.

5. The electronic instrument according to claim 4, wherein the bosses encircle the bell on an outer periphery side of the bell, when the holder is fixed to the first cymbal.

6. The electronic instrument according to claim 5, wherein the holder comprises, as the bosses, a plurality of first bosses arranged in an annular form, and a plurality of second bosses arranged in an annular form between the first bosses and the cylindrical part, and the holder is fixed to the first cymbal by having each of the headed screws screwed into the screw hole of each of the first bosses or screwed into the screw hole of each of the second bosses.

7. The electronic instrument according to claim 3, wherein the bosses encircle the center hole in the bell at a position closer to the center hole than to the bow, when the holder is fixed to the first cymbal, and
on a further outer periphery side than the bosses, the holder has no part that comes in contact with the first cymbal.

8. The electronic instrument according to claim 2, comprising:
a substrate where a circuit part of the touch sensor is formed;
a resin holder that supports the substrate and the first vibration sensor;
a nut for fixing the holder to the first cymbal;
a lead wire that electrically connects the circuit part of the touch sensor and the first cymbal; and
a conductive member connected to the lead wire, wherein the first cymbal includes a center hole,
the holder includes a cylindrical part that is inserted into the center hole, an annular plate part spreading toward an outer periphery side from a bottom end of the cylindrical part, and a male thread provided on an outer peripheral face of the cylindrical part,
the annular plate part includes a mount part for placing the conductive member,
the nut is screwed onto the male thread of the cylindrical part protruding to an upper side from the first cymbal, and abuts against an opening edge of the center hole of the first cymbal,
the conductive member is sandwiched between the mount part and the opening edge, and
on a further outer periphery side than the annular plate part, the holder has no part that comes in contact with the first cymbal.

9. The electronic instrument according to claim 2, comprising:
a second holder that supports the second vibration sensor; and
two second headed screws for fixing the second holder to a bottom face of the first cymbal, wherein
the second holder includes: a sensor support part that supports the second vibration sensor; a first screw hole provided on one side of the sensor support part; and a second screw hole provided on an opposite side from the first screw hole of the sensor support part,
the second holder is fixed to the first cymbal by having each of the second headed screws inserted into the first cymbal from an upper side to a lower side and screwed into the first screw hole and the second screw hole, and
the two second headed screws are arranged in a radial direction of the first cymbal, when the second holder is fixed to the first cymbal.

10. The electronic instrument according to claim 2, comprising:
a substrate where a circuit part of the touch sensor is formed;
a resin holder that supports the substrate and the first vibration sensor, the holder being fixed to an underside of the first cymbal;
a second cymbal comprising metal disposed coaxially on a lower side of the first cymbal; and
a distance sensor that is supported on the holder, and outputs a signal corresponding to an isolated distance between the first cymbal and the second cymbal in the top-and-bottom direction, wherein
the second cymbal is electrically conductive,
the distance sensor includes an oscillation circuit having a coil with an opening facing the top-and-bottom direction, the distance sensor outputting a signal oscillated by the oscillation circuit, and
the coil is fixed to the holder and positioned on the lower side than the first cymbal.

11. The electronic instrument according to claim 2, comprising:
a substrate where a circuit part of the touch sensor is formed;
a resin holder that supports the substrate and the first vibration sensor, the holder being fixed to an underside of the first cymbal;
a second cymbal disposed coaxially on a lower side of the first cymbal; and
a distance sensor that is supported on the holder, and outputs a signal corresponding to an isolated distance between the first cymbal and the second cymbal in the top-and-bottom direction, wherein
the second cymbal includes a conductive metal member,
the distance sensor includes an oscillation circuit having a coil with an opening facing the top-and-bottom direction, the distance sensor outputting a signal oscillated by the oscillation circuit, and
the coil is fixed to the holder and positioned on the lower side than the first cymbal.

12. The electronic instrument according to claim 10, comprising:
a cable; and
a cable guide, wherein
the second cymbal includes a wiring hole that is provided in a part of a circumferential direction and opened through the top-and-bottom direction,
the substrate includes a connector that is electrically connected to the touch sensor, the first vibration sensor, the second vibration sensor, and the distance sensor,
the cable is connected to the connector in a detachable manner while being inserted through the wiring hole from a lower side of the second cymbal, and
the cable guide is fixed to the second cymbal while being inserted through the wiring hole, and includes a pair of opposing parts opposing to the cable from both sides of the circumferential direction at positions away from the second cymbal toward the lower side.

13. The electronic instrument according to claim 10, wherein
the second cymbal has a smaller outer diameter than an outer diameter of the first cymbal, and
an outer peripheral edge of a top face of the second cymbal is covered with a shock absorbing member.

14. An electronic cymbal set, comprising:
the electronic instrument according to claim 12; and
a control device connected to the electronic cymbal via the cable,
wherein
the control device comprises:
an attack signal generation unit configured to generate an attack signal indicating a striking time point based on an output from the first vibration sensor;
a dynamic signal generation unit configured to generate a dynamic signal indicating an intensity of striking based on an output from the second vibration sensor;
a striking position signal generation unit configured to generate a striking position signal indicating a striking position on the first cymbal based on an output from the first vibration sensor and an output from the second vibration sensor;
a mute signal generation unit configured to generate a mute signal indicating mute based on an output from the touch sensor;
an isolated distance signal generation unit configured to generate an isolated distance signal indicating the isolated distance based on an output from the distance sensor; and
an output unit configured to output the attack signal, the dynamic signal, the striking position signal, the mute signal, and the isolated distance signal to outside.

15. Electronic hi-hat cymbals, comprising:
the electronic cymbal set according to claim 14; and
a hi-hat stand, wherein
the hi-hat stand includes:
a first support part that supports the first cymbal;
a second support part that supports the second cymbal; and
a lifting mechanism that lifts up and down the first support part,
wherein
when the first cymbal supported by the first support part is lifted up and down, the coil moves together with the first cymbal on the lower side than the first cymbal.
